(19) United States
(12) Patent Application Publication
(10) Pub. No.: US 2002/0085391 A1
(43) Pub. Date: Jul. 4, 2002

(54) Display structure

(75) Inventors: Ming-Shen Martin Sun, Hsinchu (TW); Kuo-Chung Lee, Yunlin Hsien (TW)

Correspondence Address: DARBY & DARBY P.C., POST OFFICE BOX 5257, NEW YORK, NY, 10150-5257, US

(73) Assignee: AU Optronics Corp.

(21) Appl. No.: 09/950,168

(22) Filed: Sep. 10, 2001

(30) Foreign Application Priority Data
Dec. 28, 2000 (TW) 89128173

(51) Int. Cl. G09F 13/18

(52) U.S. Cl. 362/559

(57) ABSTRACT

A display structure comprises a substrate formed with a slanted surface, a panel, a lamp connected with two lead wires, and an intermediate made of elastic material and used for clamping the lead wires on the substrate. When the intermediate slides on the substrate, the intermediate is compressed by the slanted surface of the substrate pressing thereon, and a wedging effect is generated between the substrate and the intermediate. The lead wires can be fixed by the compressed intermediate until the intermediate is fully disposed on the substrate. Even in instances of excessive or abrupt force being applied on the lead wires, the majority of the force is directly absorbed by the intermediate and transmitted to the substrate.

### BACKGROUND OF THE INVENTION

1. Field of the invention

This invention relates to a display structure. More particularly, this invention relates to a display structure provided an intermediate to clamp a lead wire of a lamp by wedging.

2. Description of Prior Art

FIG. 1 and FIG. 2 are two perspective views showing two prior display units P1 and P2, respectively.

In FIG. 1, the display structure P1 comprises a case H1, a panel 2, a lamp 3, two lead wires 31 (32) connected to the lamp 3, a plastic frame R1 and an elastic member T1 used for disposing on the lead wires 31 (32).

When the lead wires 31 (32) are pulled by an excessive force, the lead wires 31 (32) cannot be tightly held by the elastic member T1, and the majority of the force acts on the lamp 3 directly via the lead wires 31 (32). The lead wires 31 (32) may be disconnected from the lamp 3 by the force.

In FIG. 2, the display structure P2 also comprises a case H2, a panel 2, a lamp 3, two lead wires 31 (32) and a plastic frame R2. The display structure P2 differs from the display structure P1 in that the elastic member T1 is replaced by a tape T2, which is used for taping the lead wires 31 (32) to the case H2. When the lead wires 31 (32) are pulled by an excessive force, the tape T2 adhered to the case H2 is easily torn away, causing the lead wires 31 (32) to disconnect from the lamp.

### SUMMARY OF THE INVENTION

The primary object of this invention is to provide a display structure, which comprises a substrate, a panel, a lamp disposed on the panel, a lead wire connected to the lamp and an intermediate. The panel and the lamp are disposed on the substrate, and the lamp is disposed on the panel. The substrate has a first portion, and the intermediate, having a clamping portion and a second portion, is disposed between the lead wire and the substrate. When the lead wire is placed in the clamping portion, the intermediate enclosing the lead wire can be placed on the substrate by sliding the second portion on the first portion, and then the intermediate is elastically deformed, wedging the lead wire in the clamping portion.

### BRIEF DESCRIPTION OF THE DRAWINGS

The present invention can be more fully understood by reading the subsequent detailed description and examples with reference made to accompanying drawings in which:

FIG. 1 is a perspective view showing a display unit (P1) according to the prior art;

FIG. 2 is a perspective view showing another display unit (P2) according to the prior art;

FIG. 3 is a perspective view showing a display structure (M) according to the present invention;

FIG. 4A is an enlarged perspective view of a region (Z) according to FIG. 3;

FIG. 4B is a partially exploded view according to FIG. 4A; and

FIG. 4C is a fully exploded view according to FIG. 4A.

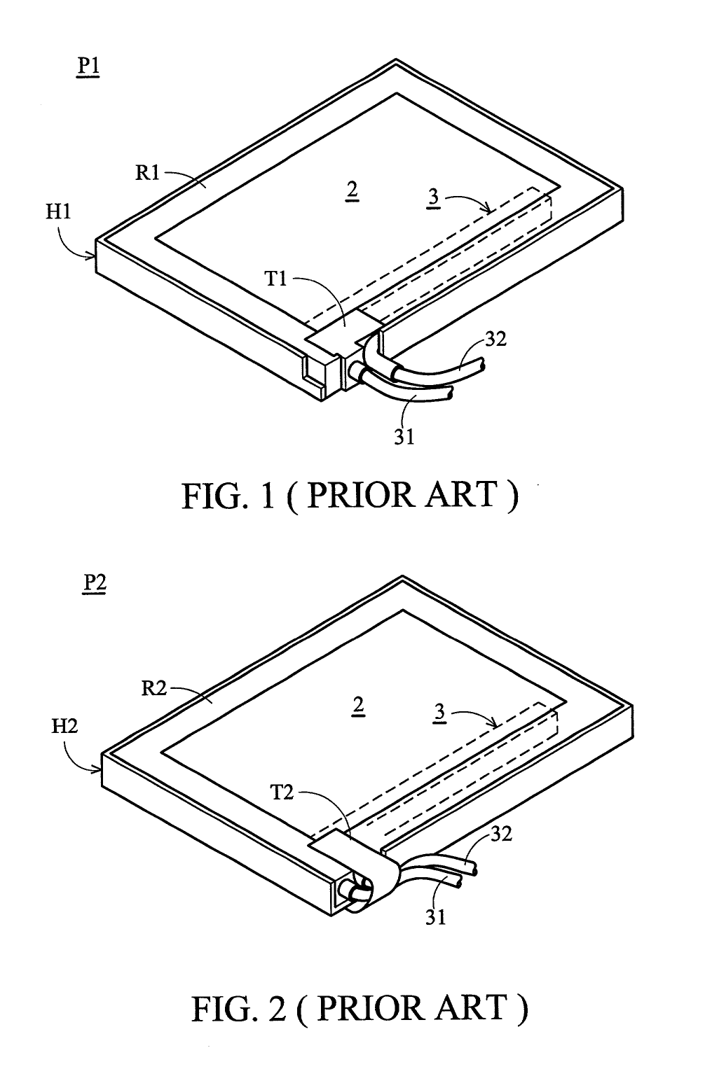

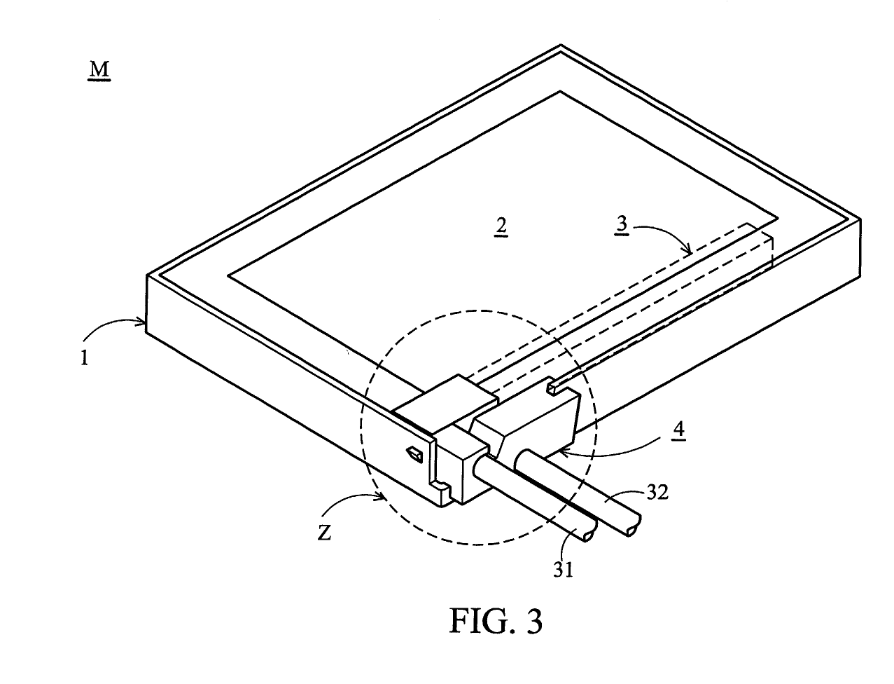

### DETAILED DESCRIPTION OF THE PREFERRED EMBODIMENTS

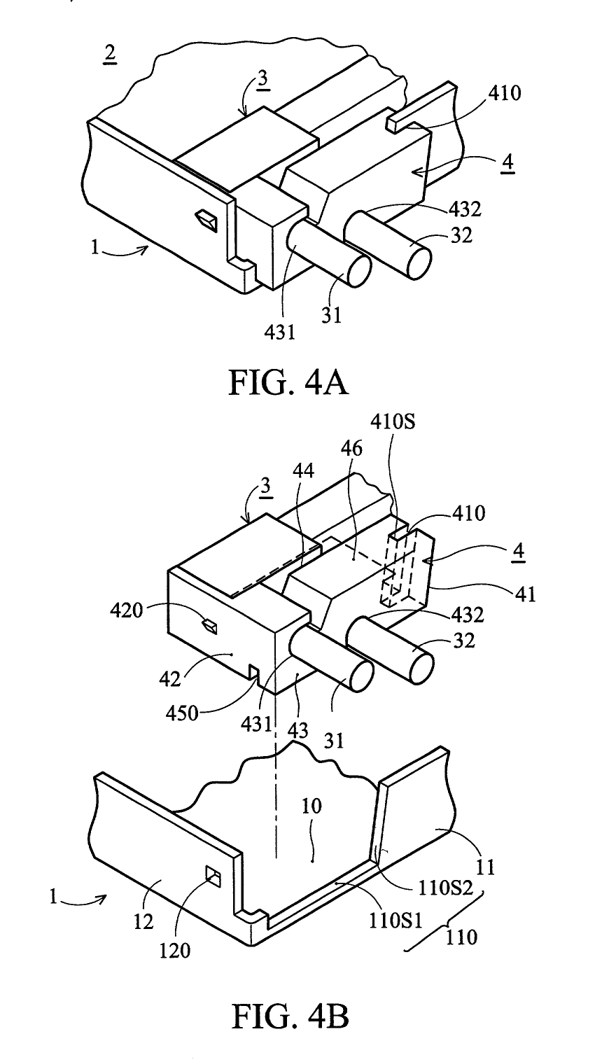

FIG. 3 is a perspective view showing a display structure M according to the present invention.

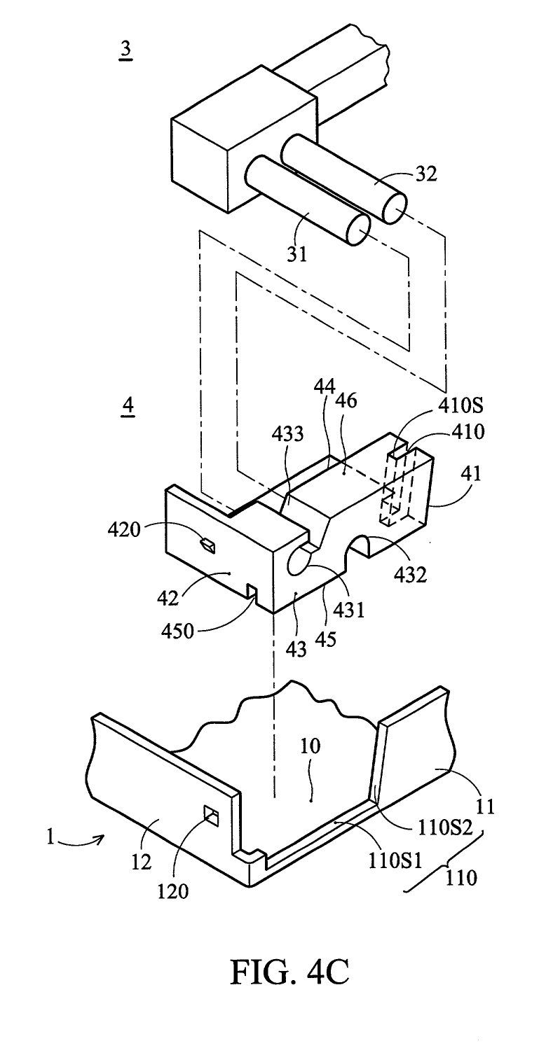

The display structure M comprises a substrate 1, a panel 2, a lamp 3, two lead wires 31 (32) connected to the lamp 3 (in FIG. 4C), and an intermediate 4 used for clamping the lead wires 31 (32) on the substrate 1. The panel 2 and the lamp 3 are disposed on the panel 2, and the lamp 3 is placed next to the panel 2. The assembly of the substrate 1 and the intermediate 4 is used as a clamping structure to hold the lead wires 31 (32) tightly in the display structure M.

FIG. 4A is an enlarged perspective view of a region Z according to FIG. 3, and FIG. 4B is a partially exploded view according to FIG. 4A, and FIG. 4C is a fully exploded view according to FIG. 4A.

In FIG. 4C, the substrate 1 comprises a bottom surface 10 and two sidewalls 11 and 12, wherein a recess 110 with two end surfaces 110S1, 110S2 is formed on the intersection between the sidewalls 11 and 12, and a hole 120 is formed on the sidewall 12. The level of the end surface 110S1 is higher than the one of the bottom surface 10, and the end surface 110S2 is a slanted surface connected to the end surface 110S1. The recess 110 is used as a first portion to position the intermediate 4.

The intermediate 4, made of elastic material such as rubber and provided with end surfaces 41, 42, 43, 44, 45 and 46, comprises a second portion 410 and two clamping portions 431 (432). The second portion 410 is a slot 410 formed on the end surface 41 and provided with a slanted surface 410S by passing the end surface 46 and 45. The clamping portion 431 is a V-shaped slot formed on the end surface 41 by passing the end surface 43 and 44. The clamping portion 432 is a slot formed on the end surface 45 by passing the end surface 43 and 44. A bump 420 is formed on the end surface 42, and a positioning slot 450 is formed on the end surface 45.

Referring to FIG. 4B, the lamp 3 with two lead wires 31 (32) is placed and positioned on the intermediate 4 before the intermediate 4 is positioned on the substrate 1. As the lamp 3 is mounted on the intermediate 4, the lead wires 31, 32 are respectively received in the clamping portions 431, 432.

Referring to FIG. 4B, the intermediate 3 enclosed with the lamp 3 is placed on the substrate 1 by sliding the second portion 410 of the intermediate 4 on the end surfaces 110S2 of the first portion 110. The end surface 110S1 of the substrate 1 is then received in the positioning slot 450 of the intermediate 4, and the bump 420 is received and positioned by the hole 120 of the sidewall 12 of the substrate 1.

As the second portion 410 of the intermediate 4 slides on the end surfaces 110S2 of the first portion 110, a wedging effect occurs. The wedging effect generates force sufficient to keep the intermediate 4 compressed and squeezing the openings of each of the clamping portions 431, 432 until the bump 420 is positioned in the hole 120, and thus the lead wires 31, 32 can be properly fixed.

When the lead wires 31 (32) are pulled by an excessive or abrupt force, the majority of the force is directly absorbed by the intermediate 4 and transmitted to the substrate 1.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A display structure, comprising:
a substrate having a first portion;
a panel;
a lamp disposed on the panel;
a lead wire connected to the lamp; and
an intermediate disposed between the lead wire and the substrate, having a clamping portion enclosing the lead wire and a second portion sliding on the first portion to cause the lead wire to be wedged by the clamping portion.

2. The display structure as claimed in claim 1, wherein the second portion is a slot.

3. The display structure as claimed in claim 1, wherein the second portion is a slot provided with a slanted surface.

4. The display structure as claimed in claim 1, wherein the clamping portion is a slot.

5. The display structure as claimed in claim 1, wherein the intermediate is made of elastic material.

6. The display structure as claimed in claim 1, wherein the intermediate is made of rubber.

7. A clamping structure for clamping a lead wire thereon, comprising:
a substrate having a first portion; and
an intermediate disposed between the lead wire and the substrate, having a clamping portion enclosing the lead wire and a second portion sliding on the first portion to cause the lead wire to be wedged by the clamping portion.

8. The clamping structure as claimed in claim 7, wherein the second portion is a slot.

9. The clamping structure as claimed in claim 7, wherein the second portion is a slot provided with a slanted surface.

10. The clamping structure as claimed in claim 7, wherein the clamping portion is a slot.

11. The clamping structure as claimed in claim 7, wherein the intermediate is made of elastic material.

12. The clamping structure as claimed in claim 7, wherein the intermediate is made of rubber.

13. A method for clamping a lead wire by a clamping structure which comprises a substrate having a first portion and an intermediate having a clamping portion and a second portion, comprising the steps of:
placing the lead wire within the clamping portion of the intermediate; and
placing the intermediate enclosing the lead wire on the substrate by sliding the second portion on the first portion to cause the lead wire to be wedged by the clamping portion.

14. The method as claimed in claim 13, wherein the second portion is a slot.

15. The method as claimed in claim 13, wherein the second portion is a slot provided with a slanted surface.

16. The method as claimed in claim 13, wherein the clamping portion is a slot.

17. The method as claimed in claim 13, wherein the intermediate is made of elastic material.

18. The method as claimed in claim 13, wherein the intermediate is made of rubber.
